(19) United States
(12) Patent Application Publication
(10) Pub. No.: US 2010/0170569 A1
(43) Pub. Date: Jul. 8, 2010

(54) AUTOMATIC SENSING SYSTEM IN SANITARY WARES

(76) Inventor: Chen Weigen, Shanghai (CN)

Correspondence Address: LADAS & PARRY LLP, 224 SOUTH MICHIGAN AVENUE, SUITE 1600, CHICAGO, IL, 60604, US

(21) Appl. No.: 12/303,597

(22) PCT Filed: Jun. 1, 2007
(86) PCT No.: PCT/IB07/01459

§ 371 Date: Feb. 20, 2009

(30) Foreign Application Priority Data
Jun. 8, 2006 (CN) 200620042500.2

(51) Int. Cl. F16K 31/02

(52) U.S. Cl. 137/1; 251/129.15

(57) ABSTRACT

An automatic sensing system used in automatic sensing sanitary wares. The main circuit board uses infrared signal on one side to detect a user, and then sends the user-detected or no-user signal through radio control to the slave circuit board inside the toilet water box. After the slave circuit board receives the radio control signal from the main circuit board, it switches on or off the solenoid valve to control flushing of the water box.

### FIELD OF INVENTION

The present invention involves an automatic sensing system used in automatic sensing toilets that includes radio control and infrared communication.

### BACKGROUND OF THE INVENTION

There are 3 major types of existing automatic sensing toilets according to the installation styles.

In the first type, the electronic sensing component is installed on the toilet, and the electronic sensing component forms a whole body with the valve body. The component detects a user from the front side. The disadvantages of this first type is that the opening and closing of the toilet cover may cause error flushing of the toilet, and the whole valve body needs to be disassembled for maintenance, which is very inconvenient.

The second type of existing automatic sensing toilets is the type in which the electronic sensing component is separate from the valve body and is installed into the wall beside the toilet. The sensing component detects a user from one side. Though this type overcomes the disadvantages of the first type, it is still connected with the solenoid valve inside the toilet with leads, which is inconvenient for lead arrangement during installation and does not present a pleasant appearance.

The third type is when the electronic sensing component is separate from the valve body and is installed into the wall beside the toilet. The sensing component detects a user from one side. Then infrared communication is used to send the signal of whether a user is detected to the flushing device. Though this type overcomes the disadvantage of the first two types, it still has 3 weak aspects: First, when the infrared receiving window is covered or blocked, flushing will fail. Second, there are certain requirements for the height and angle of the installation of main and slave board. Third, the receiving part is a free-standing device outside the water box, which prevents a pleasant look of the whole toilet.

### SUMMARY OF THE INVENTION

In order to overcome the existing problems, the present invention adopts the technical solution that the coordination of a main and slave circuit board controls the flushing of a toilet. The main circuit board uses a radio control to operate the slave circuit board inside the water box. The main circuit board includes user-sensing circuit and radio signal transmission circuit. The slave circuit board includes radio signal transmission circuit and solenoid valve drive circuit. Due to the wireless communication between the main and slave circuit board, the user-sensing main circuit becomes free-standing and can be installed anywhere around the toilet to detect a user. Additionally, there is no requirement for directions. The slave circuit board is installed inside the water box of the toilet. After the slave circuit board receives a signal, the slave circuit board drives the solenoid valve to operate the toilet flushing. The radio control signal emitted by the main circuit board can travel across the outer wall of the toilet water box and communicate with the slave circuit board. The installation of slave circuit board inside the toilet water box does not affect the look of the toilet. Furthermore, the slave circuit board can receive the radio control signals emitted by the main circuit board. This solution prevents error flushing of existing automatic sensing toilets, avoids the trouble of wire arrangement, and avoids the requirements from installation position.

It is the intention of at least an embodiment of the invention to provide an automatic sensing system comprising: a main circuit board including an infrared user-sensing module and a first radio signal transmission module; a slave circuit board including a second radio transmission module and a solenoid valve drive module; and a solenoid valve operatively connected to the slave circuit board.

It is also the intention of at least an embodiment of the invention to provide a method of operating an automatic sensing system comprising the steps of: providing a main circuit board having an infrared user-sensing module and a first radio signal transmission module; providing a slave circuit board having a second radio transmission module and a solenoid valve drive module; providing a solenoid valve operatively connected to the slave circuit board.

### DESCRIPTION OF THE DRAWING FIGURES

FIG. 1 is a flow chart of major hardware components of the main circuit board of this device.

FIG. 2 is a flow chart of major hardware components of the slave circuit board of this device.

FIG. 3 is the functioning flow chart of the whole automatic sensing system of this device.

FIG. 4 is the collated code wave schematic drawing.

### DESCRIPTION OF THE PREFERRED EMBODIMENTS

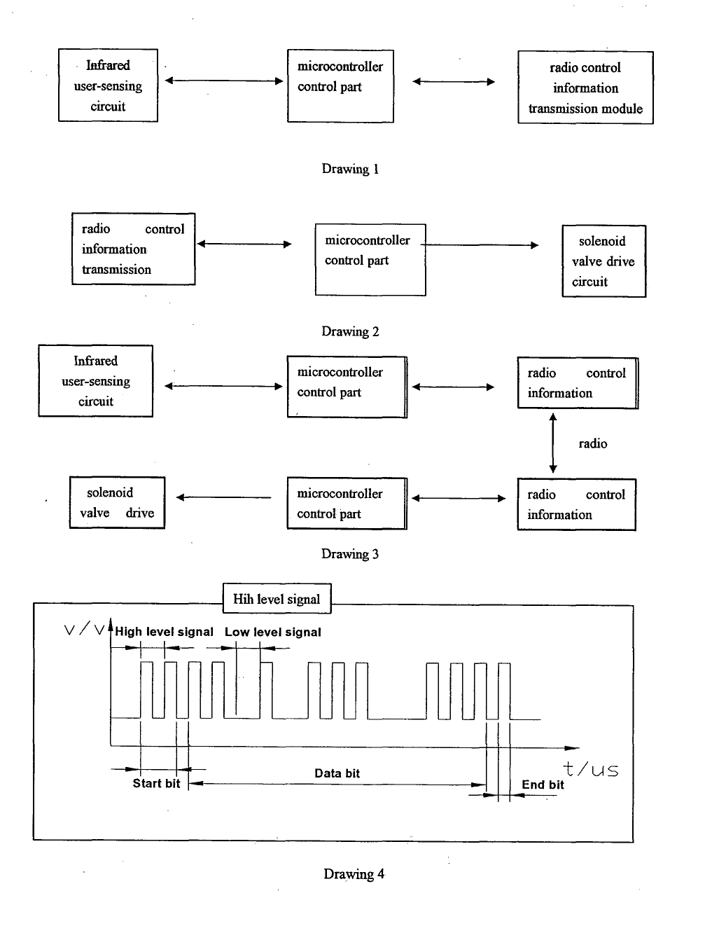

FIG. 1 illustrates the hardware components of the main circuit board of the device. The device has two major components: the main circuit board and slave circuit board. The microcontroller circuit on the main circuit board first controls the infrared user-sensing electronic module to detect whether there is a user using the toilet. If the infrared user-sensing electronic module detects a user, the pin connected to the microcontroller will produce a high level signal. After the microcontroller receives this signal, the microcontroller sends a group of data to the input end of the radio transmission module, and the radio transmission module of the main board circuit sends the data to the radio transmission module of the slave circuit board inside the water box. When the radio transmission module of the slave circuit board receives this signal, the corresponding pin on the module will show change of high and low level, based on which the microcontroller on the slave circuit board is activated. This causes the control end of the solenoid valve drive circuit set a high or low level, so that the solenoid valve drive circuit and the solenoid valve can be controlled to operate flushing. The one-to-one corresponding relationship between the main and slave circuit board is established through two ways:

First, the features of the radio transmission module determine the one-to-one corresponding relationship. The radio transmission module has codes to set pins. The codes can be used to set independent pins at high level or low levels to establish the corresponding relationship between the two modules.

Second, software programs are used to set collated codes in a microcontroller. The form of collated codes is illustrated in FIG. 4. A collated code has been set for every product, so that each product possesses its unique collated code. The collated code is a 16-bit binary number, consisting of 2-bit start bit, 13-bit data bit and 1-bit stop bit. Besides, a low-level signal is added to each bit through software. Therefore, the binary number 1 is displayed with a high level and a low level. The binary number 0 is displayed with 2 low levels. Among them, both start bit is 1, and the 13-bit data bit is a random number, which varies for every product. The last bit “+” is a stop bit. When the number is 0, it shows that the main and slave boards are in collated-code state. When the number is 1 between the main and slave boards, the state is “control solenoid valve”.

The following describes the specific collated code setting process. When the power is on, the timer inside the microcontroller begins to count. An external interruption signal to the 2 microcontroller is produced to stop the microcontroller from counting. At this time, the microcontroller records this random time constant, and after procession, the microcontroller saves the random time constant to the EEPROM. Therefore, the needed collated code is produced. The oscillation frequency adopted is 4 MHZ, so the timing precision is 1 μs. According to the demonstration form of the collated code, we know that the code can produce 2¹³ different random numbers. In actual application, at the same location, it is impossible to use more than 2¹³ products at the same time, so the repetition rate is near zero. Therefore, the collated code of the products won't interfere with each other and error operation is avoided. In the event that the main board and the slave board are carelessly mixed up when a product is produced, we can reset the collated code, so that the user doesn't have to waste time looking for the original. After the collated code is produced and processed by the microcontroller, the code is output to the infrared emitting diode in certain pulse form to send pulse signal, which is then received by the infrared receiving diode of the slave board. Afterwards, the signal is processed by the microcontroller into 16-bit collated code and saves the code into the EEPROM of the microcontroller. At this point, the collated code setting for both main and slave boards is complete.

Although the present invention has been shown and described herein by way of a preferred embodiment, it is understood that the invention may be modified without departing form the scope and spirit of the invention as defined in the following claims.

What is claimed is:

1. An automatic sensing system comprising:
a main circuit board including an infrared user-sensing module and a first radio signal transmission module;
a slave circuit board including a second radio transmission module and a solenoid valve drive module; and
a solenoid valve operatively connected to the slave circuit board.

2. An automatic sensing system of claim 1, wherein the main circuit board further comprises a microcontroller circuit that controls the infrared user-sensing circuit and the first radio signal transmission module.

3. An automatic sensing system of claim 1, wherein the slave circuit board further comprises a microcontroller that controls the second radio signal transmission module and the solenoid valve drive circuit.

4. An automatic sensing system of claim 1, wherein a one to one corresponding relationship between the main circuit board and the slave circuit board is established by the first radio transmission module.

5. An automatic sensing system of claim 4, wherein the first radio transmission module has codes to set pins, to correspond to high or low levels to establish a corresponding relationship between the main circuit board and the slave circuit board.

6. An automatic sensing system of claim 1, wherein the one to one corresponding relationship between the main and slave circuit board is established by a software program to set collated codes.

7. An automatic sensing system of claim 1, wherein the collated code exchanged between the main circuit board and the slave circuit board can be set through a setting process.

8. An automatic sensing system of claim 1, wherein the collated code further comprises a start bit, a data bit, and a stop bit.

9. A method of operating an automatic sensing system comprising the steps of:
providing a main circuit board having an infrared user-sensing module and a first radio signal transmission module;
providing a slave circuit board having a second radio transmission module and a solenoid valve drive module;
providing a solenoid valve operatively connected to the slave circuit board.

10. The method of claim 9, further comprising the step of providing a microcontroller circuit to control the infrared user-sensing module.

11. The method of claim 10, further comprising the steps of:
producing a high signal if a user is detected;
sending data to an input end of the first radio transmission module when the microcontroller receives the high signal;
sending the data from the first radio transmission module to the second radio transmission module; and
sending a signal from the slave circuit board to the solenoid drive circuit to enable the solenoid valve.
